(19) United States
(12) Patent Application Publication
(10) Pub. No.: US 2014/0268376 A1
(43) Pub. Date: Sep. 18, 2014

(54) OPTICAL SYSTEMS FOR MOBILE ELECTRONIC DEVICES

(71) Applicant: Premier Systems USA, Inc., Huntington Beach, CA (US)

(72) Inventors: Patrick D. O'Neill, Huntington Beach, CA (US); Chong Pak, Lakewood, CA (US)

(73) Assignee: Premier Systems USA, Inc., Huntington Beach, CA (US)

(21) Appl. No.: 14/214,257

(22) Filed: Mar. 14, 2014

Related U.S. Application Data
(60) Provisional application No. 61/800,215, filed on Mar. 15, 2013.

(51) Int. Cl. G03B 17/14

(52) U.S. Cl. CPC G03B 17/14
USPC 359/827; 29/428

(57) ABSTRACT

Some embodiments disclosed herein relate to an optical system with a mounting component, a light conveyance member, and an optical component. The mounting component may be removably attached to a mobile electronic device, and light entering the optical component may be conveyed to an onboard camera of the mobile electronic device via the light conveyance member. Additional embodiments disclosed herein relate to a protective case with a light conveyance member and an optical component. The protective case may be removably attached to a mobile electronic device, and light entering the optical component may be conveyed to an onboard camera of the mobile electronic device via the light conveyance member.

### CROSS-REFERENCE TO RELATED APPLICATION

This application claims the benefit of U.S. Provisional Patent Application No. 61/800,215, filed on Mar. 15, 2013 and entitled “Removable Lenses for Mobile Electronic Devices,” which is hereby incorporated by reference in its entirety and made part of this specification for all that it discloses.

### BACKGROUND OF THE INVENTIONS

1. Field of the Inventions

The inventions relate generally to accessories for mobile electronic devices (e.g., mobile telephones, mobile texting devices, mobile information storage and display devices, electronic pad devices, laptop computers, desktop computers, etc.), and specifically to removable functional components for mobile electronic devices.

2. Description of the Related Art

In recent years, many advances in computer networking and processing technology have made it possible for mobile electronic devices to include camera systems that permit users to capture images (including video). In many cases, these images can be stored, processed, manipulated, and transmitted. However, there are many design constraints on onboard cameras in mobile electronic devices that can limit the weight, size, expense, shape, adjustability, quality, features, and overall usefulness of such camera systems. Consequently, many cameras and related components in mobile electronic devices are inadequate for a wide variety of photographic needs or may not otherwise provide a wide array of features.

Some deficiencies of mobile photography in general have been addressed by purpose-built camera devices and cases for general mobile devices that serve to increase the number of environments and situations in which images may be captured. For example, stand-alone camera devices have been created for attachment to bicycle handlebars or for substantially hands-free use in various activities. As another example, cases for mobile electronic devices have been created for attachment to bicycle handlebars. These solutions provide mobile photography functionality not provided by conventional cameras and mobile devices.

### BRIEF DESCRIPTION OF THE DRAWINGS

Certain embodiments of the inventions will now be discussed in detail with reference to the following figures. These figures are provided for illustrative purposes only, and the inventions are not limited to the subject matter illustrated in the figures.

FIGS. 1A and 1B illustrate an embodiment of a removably attachable optical diversion system for use with a mobile electronic device.

FIG. 2 illustrates an embodiment of a removably attachable optical diversion system in use.

FIG. 3 illustrates an embodiment of a removably attachable remote optical system for use with a mobile electronic device.

FIG. 4 illustrates an embodiment of a removably attachable remote optical system in use.

FIG. 5 illustrates an embodiment of a removably attachable remote optical system with interchangeable optical components.

FIG. 6 illustrates an embodiment of a removably attachable remote optical system with an additional optical element.

FIGS. 7A and 7B illustrate the interior of an embodiment of a removably attachable optical diversion system.

FIGS. 8A and 8B illustrate the interior of another embodiment of a removably attachable optical diversion system.

FIGS. 9A and 9B illustrate an embodiment of a mobile device protective case with an optical diversion system.

FIGS. 10A and 10B illustrate an embodiment of a mobile device protective case with a remote optical system.

### DETAILED DESCRIPTION OF EMBODIMENTS

The following detailed description is directed to certain specific examples of embodiments of the disclosure. In this description, reference is made to the drawings wherein like parts are designated with like numerals throughout the description and the drawings. The inventions are not limited to the examples expressly illustrated or described in this specification.

The present disclosure relates generally to cameras and optical systems for mobile devices. Many different structures, features, steps, and processes are shown and/or described in discrete embodiments for convenience, but any structure, feature, step, or process disclosed herein in one embodiment can be used separately or combined with or used instead of any other structure, feature, step, or process disclosed in any other embodiment. Also, no structure, feature, step, or process disclosed herein is essential or indispensable; any may be omitted in some embodiments.

Some aspects of this disclosure relate to remote optical systems for use with mobile electronic devices. A remote optical system may be removably attachable to a mobile electronic device, and may provide photographic and/or videographic features that are not provided by a conventional mobile electronic device. For example, the remote optical system may convey or redirect light to an onboard camera lens of a mobile electronic device from an area that may not be within a field of view of the onboard camera lens. Advantageously, such remote optical systems may be mounted or otherwise positioned such that a desired photographic or videographic subject is within the field of view of the remote optical system (e.g., the remote optical system may be mounted in a high-risk position, such as on a user's bicycle helmet when the user is riding a bicycle). Images of the subject (e.g., the bicycle path as the user is travelling along it) can be captured by a mobile electronic device that is stored or positioned in a different location (e.g., a protected or safe location, such as stored in the user's pocket or backpack for safety). In some embodiments, the remote optical system may include an optical element, such as a lens, that collects and/or modifies light. The remote optical system may also include a light conveyance member, such as a fiber optic cable or a flexible bundle of optical fibers (e.g., two or more optical fibers), that convey light from the optical component generally toward an onboard camera of a mobile electronic device. The remote optical system may also include a mounting portion, such as a clip, that is removably attachable to a mobile electronic device and which positions the light conveyance member (or some other structure) in general optical alignment with the onboard camera lens of the mobile electronic device such that the light conveyance member may communicate light to the onboard camera lens. In some embodiments, the remote optical system may include optical elements that are removable or interchangeable with other optical elements. For example, various lenses, lens filters, and the like may be installed, coupled to, or otherwise used with the remote optical system to provide various photographic effects desired by a user.

Some aspects of the present disclosure relate to a removably attachable optical system that may be configured to divert light at a predetermined or adjustable angle (or range of angles) to an onboard camera lens of a mobile electronic device from an area that may not be within a field of view of the onboard camera lens. Advantageously, such optical diversion systems may be mounted or positioned such that a desired photographic or videographic subject is within the field of view of the optical system, while the mobile electronic device to which the optical diversion system is attached may be positioned in a different orientation with respect to the subject (e.g., the mobile electronic device may be posited such that the optical axis of the onboard camera lens is angled away from the photographic subject). In some embodiments, the optical diversion system may include an optical component with an element, such as a lens, that collects light. The optical diversion system may also include a static or rigid light diverting member, such as prism, mirror, lens, or light pipe that diverts light at a predetermined or adjustable angle (or range of angles) with respect to the optical component and the onboard camera lens of the mobile electronic device. The optical diversion system may also include a mounting portion, such as a clip, that is removably attachable to a mobile electronic device and which positions the light diverting member (or some other structure) in general optical alignment with the onboard camera lens of the mobile communication device such that the light diverting member may redirect light to the onboard camera lens.

Some aspects of the present disclosure relate to protective cases for mobile electronic devices. The protective cases may include remote optical systems or optical diversion systems, such as those described elsewhere in this specification, to provide various imaging features desired by users. The optical systems may be permanently or semi-permanently integrated with the protective cases such that the optical systems are not user-removable (or not meant to be user-removable). In some embodiments, the optical systems may be removably coupled to or attached to protective cases such that the optical systems are user-removable, interchangeable, replaceable, or the like.

The terms “mobile electronic devices” and “mobile devices” in this specification are used in their ordinary sense, and include mobile telephones, mobile texting devices, media players, electronic tablet devices, laptop computers, desktop computers, gaming devices, wearable electronic devices (e.g., “smart watches” or “smart eyewear”), and/or mobile electronic communication devices capable of linking electronically to another device or to a network such as the Internet, etc. Some mobile electronic devices include one or more onboard cameras that can be used for various imaging purposes, such as photography and video recording. In addition, some mobile electronic devices include one or more illumination components, such as flashes, that can be used for photography, videography, and other purposes (e.g., as a flash light).

The term “camera” in this specification is used in its ordinary sense, and includes cameras configured for still photography, videography, or both. The cameras described herein may include various lenses, or may be used with auxiliary lenses.

The terms “flash component” and “flash” in this speciation are used in their ordinary sense, and generally refer to electronic flash units to provide illumination for flash photography or for other purposes. Flash components may include one or more illumination elements, such as LEDs, xenon-based bulbs, or other light sources.

The term “lens” in this specification is used in its ordinary sense, and includes powered lenses (e.g., lenses that focus, magnify, enlarge, or otherwise alter the direction of light passing through the lens), plano lenses (e.g., lenses that are generally planar, lenses that do not taper in thickness, and/or lenses that are not powered), simple lenses, compound lenses, generally spherical lenses, generally toroidal lenses, generally cylindrical lenses, lens filters (e.g., polarizing lenses), etc.

The terms “protective case,” and “case” in this specification are used in their ordinary sense, and include removably attachable case accessories and case modules that may be attached to and detached from mobile devices by a user. Generally described, the protective cases described herein may be attached to permanent or semi-permanent housings of mobile devices, such as the housings that are provided with or form an integral part of the mobile devices. The protective cases described herein typically do not form a permanent or integral part of the mobile devices.

Although aspects of the embodiments described in the disclosure will focus, for the purpose of illustration, on the use of removably attachable optical systems, and on the use of protective cases with integrated or removably attachable optical systems, the structures and techniques disclosed herein may be applied to any accessory or auxiliary structure. For example, each of features described herein may be used by modular system in which any part is user-removable or interchangeable. Various aspects of some embodiments will now be described with regard to certain examples and which are intended to illustrate but not limit the disclosure.

Generally described, optical systems or devices can be removably attached to, or used with, mobile electronic devices to selectively enhance or otherwise change an image created from light that is transmitted through a lens to an onboard camera lens of the mobile electronic devices. Any structure and/or step of any optical systems disclosed in U.S. Pat. No. 8,279,544, which is incorporated herein by reference for all that it discloses, may be used in connection with any structure and/or step disclosed and/or illustrated in such patent. For example, an optical system can be secured to a mobile electronic device by a clip that contacts generally opposing sides of the mobile electronic device, such as by a friction fit, that resists sliding off of the mobile electronic device. Any optical systems or components disclosed in this specification may include one or more optical elements such as lenses or lens filters (e.g., fisheye, wide angle, macro, telephoto, polarizing, light-attenuating, and/or antireflective, or some other photographic lens). As described in greater detail below, optical systems may be configured to, or may include structures to, divert or convey light to an onboard camera lens of a mobile electronic device. Various examples are illustrated in the drawings and/or described in the text of this specification.

With reference to an illustrative embodiment, FIGS. 1A and 1B show a removably attachable optical diversion system 110. As shown, the optical diversion system 110 may be attached to a mobile electronic device 100. The mobile electronic device 100 illustrated in FIGS. 1A and 1B is an iPhone sold by Apple, Inc. of Cupertino, Calif. However, any other mobile electronic device can be used (e.g., other mobile phones, personal digital assistants (“PDAs”), media players, handheld gaming devices, tablet computing devices, wearable devices, and the like). In the illustrated example, an onboard camera lens 102 is positioned near a first corner of the mobile device 100 where first and second generally orthogonal sides 104 and 106 generally converge. The first and second sides 104, 106 can be located on generally opposing sides of the mobile electronic device 100 from a second corner or from third and fourth generally orthogonal sides, thereby positioning the input or output devices a substantial distance away from the third and fourth generally orthogonal sides or from the convergence thereof.

An optical diversion system 110 may include an attachable/removable mounting component 112 and an optical component 114. The mounting component 112 may be a retainer clip or other securing structure that facilitates removable attachment of the optical diversion system 110 to a mobile device 100 such that light entering the optical component 114 may be conveyed or diverted to an onboard camera lens 102 of the mobile device 100. In some embodiments, the optical diversion system 110 may be configured to clip onto a corner of the mobile electronic device 100, such that the mounting component 112 contacts generally orthogonal sides 104, 106 of the mobile electronic device 100 and/or generally parallel generally planar faces of the mobile electronic device 100 (e.g., the “front” and “rear” face of the device).

The mounting component 112 may include first and second sidewalls 120, 122, and an upper wall 126. In some embodiments, the first and second sidewalls 120, 122 and the upper wall 126 may be part of a unitary structure that forms the mounting component 112.

The first and second sidewalls 120, 122 may extend across less than the entire longitudinal or lateral distance of the first and/or second sides 104, 106 of the mobile electronic device 100. For example, one or both of the first and second sidewalls 120, 122 may extend less than or equal to about ⅓, ¼, or ⅕ down the longitudinal distance of the first edge 104. One or both of the first and second sidewalls 120, 124 may also or alternatively extend less than or equal to about ⅓, ¼, or ⅕ across the lateral distance of the second side 106. By extending less than the entire distance of one or both sides, the area of the mobile electronic device 100 that is obstructed by the mounting component 112 may be reduced or minimized. For example, many mobile electronic devices have display screens that cover substantially all of a front or rear face. By reducing the area of the mobile electronic device 100 that is blocked by the mounting component 112, the area of a display that is blocked may also be reduced. In some embodiments, as shown, one or more of the sidewalls 120, 122 can have a curvilinear shape along one or more edges to permit the mounting component 112 to provide increased distance of contact along the edge(s) of the mobile electronic device 100 while diminishing the area across a transverse surface of the device that is obstructed by the mounting component 112.

The first and second sidewalls 120, 122 of the mounting component 112 can form a channel. The width of the channel 124, e.g., the distance between the respective sidewalls 120 and 122, can be configured to be generally complimentary to the thickness of a portion of the mobile electronic device(s) on which the mounting component 112 is configured to attach. In some embodiments, the natural width of the channel 124 is approximately the same size or slightly smaller than the thickness of a corner, such as an upper corner, of the outside housing of the mobile electronic device 100 device near the light aperture of the onboard camera lens 102 (or near some other input component of the mobile electronic device 100).

All or part of the mounting component 112, such as one or more of the sidewalls 120, 122, can be made of a material (e.g., a polymer or a silicone) that is sufficiently flexible to permit deformation (e.g., compression, bending, or stretching) of one or more sidewalls 120, 122, so that the channel 124 can be temporarily widened while sliding the mounting component 112 onto a mobile electronic device 100, but at least a portion of one or more of the sidewalls 120, 122 can be sufficiently stiff, rigid, or resilient to urge one or more of the sidewalls 120, 122 to return to its original position and thereby exert a gripping force against a portion of the mobile device. The material of the mounting component 112, especially the region on the inner side of the sidewalls 120, 122 within the channel 124, can also or alternatively be tacky or somewhat slide resistant to enhance the gripping of the mounting component 112 to the communication device. For example, some portion of the interior of the sidewalls 120, 122 may include or be made of rubber, silicone, or the like.

In some embodiments, the gripping force and/or slide resistance can reduce or eliminate the need to attach a permanent or temporary mounting component to the mobile device 100. For example, the optical diversion system 110 can be repeatedly attached to and removed from a mobile device 100 without requiring (though not prohibiting) installation on the mobile device 100 of a separate permanently or semi-permanently attached fastening component such as a bracket, magnet, adhesive, or other fastening component, thereby providing ease of installation while preserving the original overall shape, appearance, functionality, compatibility (e.g., with other communication devices or cases), and/or feel of the mobile electronic device 100 when the optical diversion system 110 is removed.

The mounting component 112 can also comprise an upper wall 126 that can be shaped in some embodiments to generally correspond to the shape of one or more edges of a mobile electronic device 100. As illustrated, the upper wall 126 may have a generally curvilinear shape with a rounded corner. The mounting component 112 can also include one or more internal surface contours configured to generally avoid interference with one or more external features on a communication device. For example, the channel 124 can include a surface contour in the form of a groove to avoid interference or inadvertent contact with a button or other feature on a mobile device 100 when the optical diversion system 110 is attached to the mobile device 100.

In some embodiments, the mounting component 112 can permit the optical diversion system 110 to be attached to a mobile electronic device 100 and generally align a light conveying or diverting structure of the optical diversion system 110 with the onboard camera lens 102 of the mobile electronic device 100 (e.g., generally align the a light conveying or diverting structure with an optical axis of the onboard camera lens 102 such that light conveyed by the light conveying structure enters the onboard camera lens 102 or a light aperture thereof). When a user inserts a corner portion or some other portion of the mobile device 100 into the channel 126, the desired optical alignment may be achieved automatically without user-initiated adjustment. For example, the upper wall 126 may contact two generally orthogonal sides 104, 106 of the mobile device 100, providing automatic alignment in two dimensions with the onboard camera lens 102. One or both sidewalls 120, 122 may contact one or both generally parallel generally planar faces of the mobile device to provide automatic alignment in a third dimension. The terms “automatic alignment” and “automatically align” refer to the alignment provided by the optical system during normal installation and use, without requiring manual user adjustment or alignment, and without requiring additional alignment structures.

The mounting component 112 may be configured to secure the optical diversion system 112 to the mobile electronic device 100 and properly align the optical diversion system 110 without requiring non-stock mounts on the mobile electronic device 100, without requiring dynamic fastener components on the mounting component 112 itself (e.g. screws, adjustable clamps, etc.), and without requiring any non-stock or auxiliary guide or alignment structure on the mobile electronic device. Thus, a user can attach the optical diversion system 110 to a corner of a mobile device 100 by simply sliding it, for example, onto the corner of the mobile device 100. The configuration of one or more sidewalls 120, 122, the channel 124, and/or the upper wall 126 can ensure proper alignment by resisting or prohibiting the mounting component 112 from being attached too far onto a mobile device 100. When the user is finished using the optical diversion system 110, the user can remove it by simply pulling it off, without requiring user adjustment of any fasteners or auxiliary mounts.

In some embodiments, a mobile electronic device may have an onboard camera lens that is located between two generally parallel sides of the mobile electronic device such that the onboard camera lens is not substantially closer to one of the generally parallel sides than to the other (e.g., the onboard camera lens may be “centrally located” or substantially equidistant from each of the two generally parallel sides). An optical diversion system may be configured for use with such mobile electronic devices by contacting only one side or edge (e.g., the generally vertical side edge or the generally horizontal top edge). For example, a mounting component may contact both the front and rear surface of such side or edge but without also requiring contact with another side or edge. An example of such an embodiment can generally be formed from a mounting component with a general U-shape comprising an upper wall, two sidewalls, and a channel with an opening on each side of the side walls. As another example, a mounting component may contact two general orthogonal edges, as described above. In this example, the mounting component may cover all or substantially all of a face of the mobile electronic device between the onboard camera lens and the convergence of the two generally orthogonal edges. Alternatively, the mounting component may use first and second arms with securing structures, such as hooks, that secure the mounting component to the mobile electronic device and provide proper alignment of the optical system with the onboard camera lens of the mobile device. When attached to the mobile device, the first and second arms may extend to the first and second generally orthogonal sides of the mobile device (and “hook” to those sides) from an area generally corresponding to the location of the onboard camera lens of the mobile device.

The optical diversion system 110 can be configured to receive an optical component 114 designed or configured to enhance or alter light passing through the optical component 114 to the onboard camera lens 102 of the mobile electronic device 100. For example, the optical component 114 may include an optical element such as a fisheye lens, wide angle lens, telephoto lens, neutral density filter, ultraviolet filter, etc. These example optical elements are illustrative only, and are not intended to be limiting. In some embodiments, other types of optical elements may be used, such as macro lenses, polarizing lenses or filters, coloring lenses or filters, anti-glare lenses or filters, and the like, and any combinations thereof.

A user may use one optical component 114, such as one with a fisheye lens, while taking photographs with the mobile electronic device 100. The user may then detach or decouple the optical diversion system 110 from the mobile electronic device 100 for storage when the optical diversion system 110 or mobile electronic device 100 is not in use. In some embodiments, the individual optical component 114 of the optical diversion system 110 may be replaced by some other optical component 114, or the optical element within the optical component may be replaceable. A user may remove the optical component 114 from the mount 116 (e.g., by unscrewing the optical component 114 from a threaded mount, by removing the optical component 114 from a bayonet mount, etc.) and replace the optical component 114 with a different component (e.g., replace with an optical component including a fisheye lens with a wide angle lens, polarizing lens or filter, etc.).

The optical component 114 may accept light from an area generally in front of the optical component 114, where “in front” refers to an area in the direction of the optical axis of the lens or other optical element of the optical component 112, or an area within a field of view of the lens or other optical element of the optical component 112. The optical diversion system 110 can divert or focus the light generally towards the onboard camera lens 102 of the mobile electronic device 100. As seen in FIGS. 1A and 1B, the optical component 114 may be oriented with respect to the onboard camera lens 102 such that the optical component 114 can collect light to capture images at the onboard camera lens 102. For example, the optical component 114 may be positioned such that the optical axis of the optical component 114 is or can be oriented with respect to the optical axis of the onboard camera lens 102 at one or more angles spaced away from the straight-forward line of sight of the onboard camera lens 102 of the mobile electronic device, such as at an angle of at least about 30 degrees, at least about 45 degrees, at least about 60 degrees, at least about 90 degrees, or some other angle. As described below with respect to FIGS. 7 and 8, the optical diversion system 110 may include any type of optical light-direction reorienting device, such as a prism, mirror, lens optical fiber, light pipe, or the like, to facilitate redirecting or diverting the light generally toward the onboard camera lens 102.

As shown in FIG. 2, in some embodiments the mobile electronic device 100, with the optical diversion system 110 attached thereto, may be mounted on, or otherwise coupled to, another functional device, such as a vehicle, a tripod, a computer screen, or a user-worn device, such as a helmet 130. Such a mount can facilitate the capture of images or video while a user is engaged in various activities (e.g., physical activities such as hiking, running, biking, skateboarding, and the like), thereby freeing the user's hands for use in the activity. The diversion of light by the optical diversion system 110 (e.g., about 90 degrees from an area generally in front of the user toward the onboard camera lens 102) can allow the mobile electronic device 100 to be placed on the other functional device (e.g., helmet 130) in a position that can reduce or minimize the effects of wind drag or other photographic challenges that may arise when using the mobile electronic device 100 in the ordinary straight-forward photographic mode. Without such a diversion of light, the mobile electronic device 100 may need to be mounted such that the onboard camera lens 102 faces the direction from which images are to be captured. Because onboard camera lenses 102 are generally located on a front or rear generally planar face of a mobile electronic device 100, orienting the device 100 such that the onboard camera lens 102 is facing the proper direction can introduce a substantial amount of wind drag. As seen in FIG. 2, the mobile electronic device 100 may be mounted on the helmet 130 such that only an edge 106 is facing the direction in which the user will typically travel, rather than an entire generally planar face 108 of the mobile electronic device 100.

In some embodiments, an user may desire to capture images with an optical component mounted or positioned in a location that is remote from the mobile electronic device 100 on which the images will be stored and/or viewed. FIG. 3 illustrates an embodiment of a remote optical system 150 that includes an optical component 152 able to be mounted or positioned remotely from the mobile electronic device 100.

The optical component 152 of the remote optical system 150 shown in FIG. 3 may communicate information (e.g., light or energy) to an onboard camera lens 102 of a mobile electronic device 100 such that the mobile electronic device 100 may capture images from a remote location (e.g., the lens and the mobile electronic device 100 may be in two separate, spaced apart locations). Remote optical system 150 provides a remote optical component 152 and an attachable/removable mounting component 154. A flexible light conveyance member 156 facilitates transfer of light or energy from the remote optical component 152 to the mounting component 154, where it is then conveyed to an onboard camera lens 102 of a mobile electronic device 100. A remote optical component 152 may include an optical element (e.g., lens) that focuses or alters light, as described above, and conveys the light to the flexible light conveyance member 156. In some embodiments, the remote optical component 152 can be configured to be positioned in one or more different locations where it would be difficult or impossible to position the onboard camera lens 102 and/or the mobile electronic device 100 or where the onboard camera lens 102 and/or the mobile electronic device 100 would be exposed to a high level of risk of damage. For example, in some embodiments, the remote optical component 152 can be positioned in or through a small opening, such as a sink drain, or around a corner, or on a moving vehicle, or under a door.

In some embodiments, the flexible light conveyance member 156 may be an individual optical fiber, a fiber optic cable comprising multiple (e.g., two or more) optical fibers, or the like. For example, the flexible light conveyance member 156 may include a fiber optic cable comprising tens of thousands or hundreds of thousands of individual optical fibers. Optical fibers may be used to convey light or energy from one end of the optical fiber to another end. In the present example, an optical fiber can therefore allow viewing of an image at one end of the fiber from light originally collected at another end of the fiber. Each optical fiber may convey light or information corresponding to a single unit of a complete image, such as a single pixel of an image. A bundle of multiple optical fibers may therefore provide an image made of multiple individual pixels.

The remote optical component 152 may include a permanently attached optical element, such as a fisheye lens, wide angle lens, anti-glare filter, etc. In some embodiments, as shown in FIG. 5, the remote optical component 152 may support removal and replacement of individual interchangeable optical elements 160, such as those described above (e.g., wide angle lenses, telephoto lenses, ultraviolet filters, polarizing lenses, and the like). In some embodiments, the remote optical component 152 and/or the flexible light conveyance member 156 can be removable and/or replaceable separately from one or more other components of the remove lensing system 150.

The attachable and removable mounting component 154 may be configured to clip onto a corner of the mobile electronic device 100, such that the mounting component 154 contacts generally orthogonal sides of the mobile electronic device 100 as described above with respect to the mounting component 112 of the optical diversion system 110. The attachable and removable mounting component 154 may include first and/or second sidewalls 120, 122, an upper wall 126 extending between the first and second sidewalls 120, 122, or some combination of one or more sidewalls and/or an upper wall. In some embodiments, the first and second sidewalls 120, 122 may form a channel 124 into which a portion of a mobile electronic device 100 may be inserted. The mounting component 154 may be attached to and/or detached from the mobile device 100 in a manner that is similar or identical in many respects to the mounting component 112 described above. In addition, the mounting component 154 may facilitate alignment of one end of the flexible light conveyance member 156 (or some other structure) with the onboard camera lens 102 of the mobile electronic device 100 in a manner that is similar or identical in many respects to the mounting component 112 described above.

The light conveyance member 156 may extend into the mounting component 154 and may be positioned such that it contacts or is brought into very close proximity with the onboard camera lens 102 so as to convey light to the onboard camera lens 102. In some embodiments, a prism, mirror, or some other component that may alter the path of light may be used in the mounting component 154 to divert incoming light generally to the onboard camera lens 102.

In some embodiments, due to the flexible nature of some fiber optic cables, the remote optical component 152 may be positioned freely at a plurality of different angles with respect to the mobile electronic device 100. For example, the remote optical component 152 may be positioned on a helmet 130, as seen in FIG. 4. The remote optical component 152 may be coupled to the top of the helmet 130. However, because the remote optical component 152 may be positioned remotely from the mobile electronic device 100, the remote optical component 152 may be positioned on the helmet by itself or without the mobile electronic device 100. In this configuration, the mobile electronic device 100, and the mounting component 154 with which it receives light from the remote optical component 152, may be positioned in a high-risk location (e.g., increased risk of damage), such as on the side of the helmet, at the rear of the helmet, inside the helmet, or somewhere else entirely. Depending upon the length of the light conveyance member 156, the mobile electronic device 100 may be located in a safe or protected location, such as in a pocket of an article of the user's clothing (e.g., the user's jacket or pants), or in a carrying receptacle (such as in a backpack), etc., while the remote optical component 152 is positioned in a location (e.g., on the helmet 130) that is remote from the mobile electronic device 100. Placement of the remote optical component 152 on a helmet 130 in FIG. 4 is illustrative only, and is not intended to be limiting. In some embodiments, the remote optical component 152 may be clipped to a user's shirt, coupled to a user's eyeglasses, or located in some other position remote from the mobile electronic device 100.

In some embodiments, a one or more secondary or additional optical elements 170 may be included in or used with the mounting component 154. Such a secondary optical element 170 can provide additional photographic features, such as a polarizing filter, in addition to optical features provides by the optical element 160 used in the remote optical component 152. The mounting component 154 may include a removable structure 162, such as a cap, the removal of which allows a secondary optical element 170 to be added or removed. The removable structure 162 may be coupled to the light conveyance member 156, and may include components that divert light from the light conveyance member 156 toward the onboard camera lens 102 via the secondary lens 170, if one has been installed. In some embodiments, a secondary lens 170 is not required to obtain the benefits of the remote optical system 150.

In some embodiments, a remote optical system 150 may be configured with an illumination element (not shown). The illumination element may be a video light (e.g., a bulb or light emitting diode (“LED”)) that can stay illuminated for a lengthy period of time, such as while capturing video. In some embodiments, an illumination element may be a flash component for flash photography. The illumination elements may be powered by the mobile electronic device (e.g., via an electrical connection directly or indirectly to a battery of the device), or by an external power source (e.g., a battery within the remote optical component 152). The illumination element may be actuated via wired or wireless communication with the mobile electronic device. In some embodiments, the illumination element may convey light that is produced by a flash component 103 or video light of the mobile electronic device to an area generally in front of the remote optical component. For example, one or more optical fibers of the light conveyance member 156 may be used to convey light from the flash component 103 of the mobile device 100 to the illumination element of the remote optical component 152. In some embodiments, a separate light conveyance member may be used to convey light from the mobile electronic device to the remote optical component 152 or otherwise to the photographic subject. The light conveyed from the mobile electronic device can then be reflected off of the subject or scene to be photographed or videoed, captured by the remote optical component 152, and then conveyed through the light conveying member 156 back to the mobile electronic device 100 near the region of the onboard camera 102.

FIGS. 7A, 7B, 8A and 8B illustrate embodiments of optical diversion systems 210, 250 that implement various structures and methods for diverting light toward an onboard camera lens. In some embodiments, as shown in FIGS. 7A and 7B, an optical diversion system 210 may include an optical element 216 that is permanently or removably attachable to a mounting component. As described above, the optical diversion system 210 may be permanently or removably attached to a mobile electronic device using any or all of the features, structures, and/or steps illustrated or described herein. For example, the optical diversion system 210 may be configured to clip onto a corner of the mobile electronic device. The optical element 216 may collect light from an area generally in front of the optical element 216 for conveyance to an onboard camera lens of the mobile electronic device.

The optical element 216 may be oriented at an angle with respect to the onboard camera lens of the mobile electronic device. For example, the optical element 216 may be oriented such that the optical axis of the optical element 216 is generally orthogonal to the optical axis of the onboard camera lens. In some embodiments, the optical element 216 may be oriented at any number of different angles with respect to the onboard camera lens. In some embodiments, the particular angle may be set permanently, while in other embodiments optical element 216 may be temporarily re-oriented in a plurality of different angles with respect to the onboard camera lens.

The optical diversion system 210 may include a light diversion structure 218, such as a reflecting and/or a refracting structure (e.g., a prism or mirror, or a combination thereof). The light diversion structure 218 may be configured to turn, divert, reflect, or otherwise refract light passing through the optical element 216 away from a first path or direction and generally toward a second path or direction. An onboard camera lens of a mobile electronic device on which the optical diversion system 210 is mounted may be generally aligned with the second path.

FIGS. 8A and 8B show another embodiment of an optical diversion system 250. The optical diversion system 250 may be similar or identical in many respects to the optical diversion system 210 shown in FIGS. 7A and 7B and described above. For example, the optical diversion system 250 may include an optical element 246 that is attached or coupled to a mounting component. The optical diversion system 250 may also include a light diversion structure 258. The light diversion structure 258 may be an optical fiber, a light pipe, etc. The light diversion structure 258 may be configured to convey light, passing through the optical element 256, along a generally curved path or around an angle. The path of the light may be altered to convey the light to an onboard camera lens of the mobile electronic device on which the optical diversion system 250 is mounted.

FIGS. 9A and 9B illustrate an optical diversion system 310 configured for use with mobile electronic devices 300 onto which protective cases 304 have been installed. The optical diversion system 310 may be similar or identical in many respects to optical diversion systems described above. For example, the optical diversion system 310 may include an optical element, such as a lens or lens filter through which light may pass, a light diversion structure such as a prism or optical fiber that can convey light from the optical element to an onboard camera lens 102 of a mobile device, etc.

The protective case 304 may be any case that is installed onto a mobile device 310 to provide some degree of protection. For example, the protective case 304 may be a high-performance, rugged, or damage-resistant case for mobile electronic devices to enclose and/or protect mobile electronic devices from various hazards, such as impact, shock, and/or ingress of potentially damaging substances, such as water, other liquids, dust, dirt, sand, and/or other debris, etc. As another example, the protective case 304 may be a slim case with dimensions close to corresponding dimensions of the mobile electronic device 310, thereby providing an overall size that is not much larger than the bare mobile electronic device 300 while still providing protection and the optical diversion features described below. In some embodiments, the case 304 may not be a protective case, but rather may be a case that provides some desired aesthetic feature to the mobile phone. In other embodiments, the case may not be designed to provide any protective or aesthetic features, but rather may be designed only to facilitate use of the optical diversion system 310 with a mobile electronic device.

The protective case 304 may include an interior cavity that is sized to removably receive a mobile electronic device 300 (or some portion thereof). In some embodiments, a user may insert a mobile electronic device 300 into the case 304 by placing the mobile device 300 (or some portion thereof) in the interior cavity when the case 304 is in an open position, as shown in FIG. 9A. After the mobile electronic device 300 is inserted into the interior cavity 300 of the case 304, a cover portion of the case 304 can be pivoted toward a generally planar face of the mobile device 300 and into a closed position. One or more securing mechanisms, such as latches, can removably secure the cover portion of the case 304 in a closed position. FIG. 9B shows an example of a case 304 in the closed position.

In some embodiments, a case may not include a cover portion that pivots toward a generally planar face of a mobile device, but rather a lid portion that pivots toward an edge of a mobile device 300. For example, the case may include an interior cavity into which a mobile device 300 may be inserted in a manner similar to that in which an object is inserted into a sheath. A lid portion may then be pivoted toward an edge of the mobile device 300, such as an exposed top, bottom, or side edge, and into a closed position. In some embodiments, a case may not include a cover portion or a lid portion, and/or may not be configured to provide an open position and a closed position. Rather, the case may be a slip-on case, a “bumper” case, or some other case that may be installed onto a phone without use of a cover, lid, or opening/closing of any structure.

An optical diversion system 310 may be coupled to, or integrated with, a protective case 304 so as to convey light from outside of the case 304 to an onboard camera lens 102 of a mobile electronic device 300 within the case 304. For example, an optical diversion system 310 may be mounted to a case 304 via a threaded screw mount, a bayonet mount, or the like. The optical diversion system 310 may convey light directly or substantially directly to an onboard camera lens 102 of a mobile electronic device 300 via an aperture in a portion of the case 304. In some embodiments, the optical diversion system 310 or the case 304 may include a light conveyance structure or a light diversion structure (e.g., a light pipe, a glass or other translucent pane, etc.) through which light is conveyed from the optical diversion system 310 to the onboard camera lens 302.

The optical diversion system may be coupled to or integrated with the case 304 in a location that generally corresponds to the location of the onboard camera lens 102 of the mobile device 300 when the protective case 304 is installed on the mobile device 300. For example, as shown, the optical diversion system 310 can be located in a corner region of the case 304, closer to a portion where first and second generally orthogonal sides of the case 304 generally converge, and opposite a second corner or a location where third and fourth generally orthogonal sides generally converge. In this configuration, the light diversion or conveyance structure that provides light from the optical element to the onboard camera lens can be small and the overall optical system 310 may be compact.

In some embodiments, the optical diversion system may be coupled to or integrated with the case 304 in a location that is away from a location that generally corresponds to the onboard camera 102 of the mobile device 300 when the case 304 is installed on the mobile device. For example, the optical system 310 may be located on an edge of the case 304, on a generally planar face of the case 304 that is opposite or generally parallel to the generally planar face that corresponds to the face of the mobile device that comprises the onboard camera lens, etc. The optical system 310 may generally be located at any advantageous or desirable location on the case 304, so long as some light diversion or light conveyance structure is present to divert or convey light from the optical diversion system 310 to the onboard camera lens 102 of the mobile device 300.

In some embodiments, the optical diversion system 310 may be configured to accept removable and interchangeable optical elements, as described above. In some embodiments, the mobile electronic device 300, with the protective case 304 and optical diversion system 310 installed thereon, may be mounted in various positions or on various objects. For example, the protective case 304 with the mobile electronic device 200 and optical diversion system 310 may be mounted on a user's helmet, as described above, on bicycle handles, or the like.

FIGS. 10A and 10B illustrate a remote optical system 350 configured for use with mobile electronic devices 300 onto which protective cases 340 have been installed. The remote optical system 350 may be similar or identical in many respects to remote optical systems described above. For example, the remote optical system 350 may include an optical component 352 that has an optical element, such as a lens or lens filter through which light may pass. The remote optical system 350 may also include an elongate light conveyance member 354 that can convey light from the optical element to an onboard camera lens 102 of a mobile device, etc.

The protective case 340 may be similar or identical in many respects to the protective case 304 described above. For example, the protective case 304 may be a high-performance rugged case, a slim case, an aesthetic case, or a case intended simply to provide remote optical features. In addition, the case 340 may include an interior cavity into which a mobile electronic device 300 may be placed, and a cover or lid portion that pivots into a closed position.

Remote optical systems, such as those integrated with or used in conjunction with protective cases 340, or those that are removably attachable to mobile electronic devices with or without protective cases, may be used in a variety of manners. For example, a remote optical component may be mounted in or on the outside of moving vehicles, such as to a side-view mirror of a vehicle. In some embodiments, the mechanism by which the remote optical component is mounted may include use of a resilient band or belt, a metallic or polymer mounting bracket, or the like. As described above, the remote optical component may transmit light and images to a mobile electronic device via a light conveyance member, such as an optical fiber or cable, thereby allowing the mobile electronic device to remain safely inside the vehicle and to be directly operated by the driver or a passenger of the vehicle.

As another example, a remote optical component mounted to a user, or to some device or article of clothing that the user is wearing. In some embodiments, the remote optical component may be mounted using a personal attachment, such as a wrist band, belt clip, pin, hat clip, etc. As described above, the remote optical component may transmit light and images to a mobile electronic device via a light conveyance member. The remote optical component, light conveyance member, and/or other components of the remote optical system may be water resistant or substantially waterproof, and electronic components for capturing an image via the remote optical system may be attached to or integrated with underwater recreational equipment, such as swimming or SCUBA goggles. In some embodiments, a protective case 340 such as those shown in FIGS. 10A and 10B may be used. Such cases may be water resistant, and may also be attachable to the user or to the user's equipment. In some embodiments, a protective case 304 with an optical diversion system, such as those shown in FIGS. 9A and 9B, can be used in a similar manner.

As a further example, a remote optical system may be used with a personal carrying item, such as a backpack. A remote optical component may be mounted on a helmet, as described above, or on some location on a user's body, or to a piece of equipment that the user is using (e.g., bicycle handlebar, ski, etc.). The remote optical component may convey images or light via a light conveyance member to a mobile electronic device that is located within the personal carrying item. In some embodiments, the personal carrying item may include an interface, such as a port or plug, to which both the light conveyance member and the mobile electronic device may connect. The interface can allow images or light to be transmitted from the light conveyance member to the mobile electronic device via the interface. In other embodiments, the personal carrying item may include an aperture or opening through which the light conveyance member may pass.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention.

The following is claimed:

1. A removably attachable optical system for use with a mobile electronic device, the optical system comprising:
a light conveyance member comprising a first end and a second end;
a mounting component comprising first and second sidewalls forming a channel, the distance between the first and second sidewalls generally corresponding to a thickness of a portion of a mobile electronic device over which the mounting component is configured to fit, wherein the mounting component is coupled to the first end of the light conveyance member; and
an optical component coupled to the second end of the light conveyance member, wherein the optical component is in optical communication with an onboard camera lens of the mobile electronic device via the light conveyance member such that at least a portion of light entering the optical component is conveyed to the onboard camera lens.

2. The removably attachable optical system of claim 1, wherein the light conveyance member comprises a flexible elongate light conveyance member.

3. The removably attachable optical system of claim 2, wherein the light conveyance member comprises a fiber optic cable.

4. The removably attachable optical system of claim 1, wherein the light conveyance member comprises a rigid light conveyance member.

5. The removably attachable optical system of claim 4, wherein the light conveyance member comprises a prism or a light pipe.

6. The removably attachable optical system of claim 1, wherein the optical component is coupled to the mounting component.

7. The removably attachable optical system of claim 1 wherein the optical component is operable from a location remote from the mounting component.

8. The removably attachable optical system of claim 1, wherein at least one of the first and second sidewalls is configured to extend along the less than an entire first edge of the mobile electronic device.

9. The removably attachable optical system of claim 1, wherein the optical component comprises an optical element in communication with the light conveyance member, the optical element configured to modify light received by the onboard camera lens via the light conveyance member.

10. The removably attachable optical system of claim 9, wherein the optical element comprises one of a macro lens, a wide angle lens, a fisheye lens, a telephoto lens, or a lens filter.

11. The removably attachable optical system of claim 1, wherein the mounting component comprises an optical element in communication with the light conveyance member, the optical element configured to modify light received by the onboard camera lens via the optical element

12. The removably attachable optical system of claim 1, wherein an optical axis of the optical component is not in alignment with an optical axis of the onboard camera lens, and wherein the light conveyance member redirects light from the optical component generally into alignment with the optical axis of the onboard camera lens.

13. A case configured to be removably attachable to a mobile electronic device by a user, the case comprising:
an interior cavity configured to removably receive at least a portion of a mobile electronic device;
a light conveyance member comprising a first end and a second end, wherein the first end is in optical alignment with an onboard camera lens of the mobile electronic device; and
an optical component coupled to the second end of the light conveyance member, wherein the optical component is in optical communication with the onboard camera lens of the mobile electronic device via the light conveyance member such that at least a portion of light entering the optical component is conveyed to the onboard camera lens.

14. The case of claim 13, wherein the light conveyance member comprises a flexible elongate light conveyance member.

15. The case of claim 14, wherein the light conveyance member comprises a fiber optic cable.

16. The case of claim 13, wherein the light conveyance member comprises a rigid light conveyance member.

17. The case of claim 16, wherein the light conveyance member comprises a prism or a light pipe.

18. The case of claim 13, wherein the case is water resistant.

19. The case of claim 13, wherein the optical component comprises an optical element in communication with the light conveyance member, the optical element configured to modify light received by the onboard camera lens via the light conveyance member.

20. The case of claim 19, wherein the optical element comprises one of a macro lens, a wide angle lens, a fisheye lens, a telephoto lens, or a lens filter.

21. A method of manufacturing an optical system for use in redirecting light to be received by an onboard camera of a mobile electronic device, the method of manufacturing the optical system comprising:
providing a light conveyance member comprising a first end and a second end;
providing a mounting component comprising first and second sidewalls forming a channel, the distance between the first and second sidewalls generally corresponding to a thickness of a portion of a mobile electronic device over which the mounting component is configured to fit;
attaching the mounting component to the first end of the light conveyance member;
providing an optical component; and
attaching the optical component to the second end of the light conveyance member such that the optical component will be in optical communication with an onboard camera lens of the mobile electronic device to which the mounting component has been removably attached.

22. The method of claim 21, wherein the optical component comprises an optical element configured to modify light provided to the light conveyance member.

23. The method of claim 22, wherein the optical element comprises one of a macro lens, a wide angle lens, a fisheye lens, a telephoto lens, or a lens filter.

24. The method of claim 21, wherein the light conveyance member comprises a flexible elongate light conveyance member.

25. The method of claim 21, wherein the light conveyance member comprises a rigid light conveyance member.
